(19) United States
(12) Patent Application Publication
(10) Pub. No.: US 2008/0088804 A1
(43) Pub. Date: Apr. 17, 2008

(54) Method, System and Apparatus for Diffuser Vibration

(76) Inventors: Mark Peterson, Lake Oswego, OR (US); Kyrre Tangen, Fredrikstad (NO); Denise Myers, Washougal, WA (US); Dan Loomis, Portland, OR (US)

Correspondence Address: ALLEMAN HALL MCCOY RUSSELL & TUTTLE LLP, 806 SW BROADWAY, SUITE 600, PORTLAND, OR, 97205-3335, US

(21) Appl. No.: 11/871,951

(22) Filed: Oct. 12, 2007

Related U.S. Application Data
(60) Provisional application No. 60/851,419, filed on Oct. 13, 2006.

(51) Int. Cl. G03B 21/14

(52) U.S. Cl. 353/69; 353/121

(57) ABSTRACT

Methods, systems and apparatus for diffuser vibration to reduce speckle in a laser display device are provided. In some embodiments, a coil is operatively coupled to the diffuser to generate the desired vibrations in the diffuser. In some embodiments, an air jet may be operatively coupled to the diffuser such that vibrations from the air jet are transferred to the diffuser. In other embodiments, parasitic vibrations from other components in the laser display device may be used to vibrate the diffuser without requiring an additional motor dedicated to only vibrating the diffuser.

### CROSS-REFERENCE TO RELATED APPLICATIONS

This application claims priority from U.S. Provisional Patent Application Ser. No. 60/851,419 of Mark Peterson, Kyrre Tangen, Denise Meiers, and Dan Loomis, for METHODS, SYSTEMS, AND APPARATUS FOR DIFFUSER VIBRATION, filed Oct. 13, 2006, the disclosure of which is hereby incorporated by reference in its entirety and for all purposes.

### BACKGROUND

Image projection via laser light sources offers various advantages over the use of conventional lamp light sources. For example, diode laser light sources may be substantially smaller, consume less power, and last longer than conventional lamps, yet may offer sufficient brightness for projection under many light conditions. Projection devices utilizing laser light sources may therefore be used in a variety of different environments. For example, laser projection devices may be used in front projectors, rear projectors, pocket projectors, home projectors, business presentation projectors, etc.

Current laser projection systems may utilize three laser sources, each providing a beam of a primary color. In these systems, the laser sources provide an illumination beam that is then passed through an imaging device where an image is combined with the illumination beam and then projected. For example, in some systems, the three beams may be pulsed through dichroic combiner optics, which may be raster scanned to create an image for projection. Other suitable systems may be used to combine the laser light to form an image for projection.

A laser typically uses a common stimulus to trigger emission events to provide amplified light, emitted photons from a laser source have a definite phase relation to each other and are coherent. Coherent laser light can create speckle when projected on a screen, and interfere with the image quality. Speckle is a random intensity pattern and can be caused by a mutual interference of coherent waves with either fluctuations in intensity or as phase differences between the waves. Speckle patterns generally appear granulated and can otherwise significantly degrade the image quality of laser projection devices.

As discussed below in more detail, one method for reducing apparent speckle in a generated image involves using a motor to vibrate a diffuser in a light path. The vibration may cause the speckle pattern to vibrate and for vibration frequencies greater than 60 Hz, the human eye integrates the light patterns and thereby reduces speckle effects. An example diffuser vibration motor includes piezoelectric crystals attached to one side of an arm which is attached to a diffuser, whereby the motor vibrates the diffuser.

The inventors herein have recognized difficulty related to incorporating a motor into a projector to vibrate a diffuser due to limited space in the projector. Specifically, with small projectors such as pocket projectors, space may be at a premium and a motor may not only take up space, it may increase cost for the projector and it may also increase heat in the device.

### SUMMARY

A display device and method for displaying images with reduced speckle is provided. The display device may include, amongst other structure, a laser light source to provide laser light to an imaging device to project at least a partial image onto a surface, optics in an optical path of the laser light to optically adjust the laser light, and a diffuser in the optical path of the laser light before the laser light reaches the imaging device. A coil may be operatively connected to the diffuser, in order for the diffuser to be vibrated by a change in electrical current through the coil, and thereby diffuse the laser light and reduce speckle in a projected image. Other embodiments may vibrate the diffuser with structure other than a coil.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE FIGURES

FIG. 1 shows a schematic depiction of a first exemplary embodiment display device including a coil to vibrate a diffuser according to the present disclosure.

FIG. 2 shows a schematic depiction of a second exemplary embodiment of display device including an air jet to vibrate a diffuser according to the present disclosure.

FIG. 3 is a flow diagram of a method of vibrating a diffuser in a display device in order to reduce speckle in a projected image.

### DETAILED DESCRIPTION OF THE DEPICTED EMBODIMENTS

As discussed above, a projection system may incorporate a laser light source. Although the following description is described in regards to a pocket projector, it should be appreciated that the present disclosure is not so limited and may be applied to any suitable laser projection system, including presentation projectors, home entertainment projectors, front projectors, rear projectors, etc.

In laser projectors, such as small pocket laser projectors, a light source is coherent and may create speckle in a generated image displayed on a screen. One approach to reduce or substantially eliminate speckle is by vibrating a diffuser or other similar component positioned in the laser light path. By vibrating a diffuser in the laser light path, prior to an imaging device, the image generated by a display device to be displayed on a screen vibrates, thereby reducing or substantially eliminating the speckle in the displayed image. Further, when the diffuser is vibrated at frequencies greater than 60 Hz the human eye may integrate the speckle patterns and the visual speckle may be reduced or substantially eliminated.

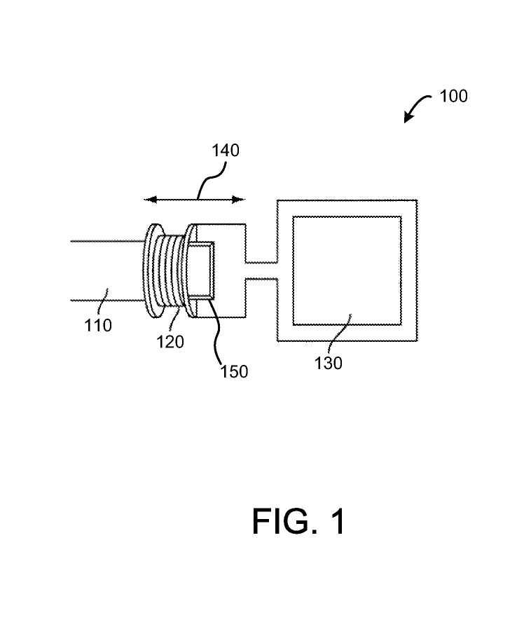

Referring first to FIG. 1, a first exemplary embodiment 100 for vibrating a diffuser 130 is provided. Diffuser 130 is coupled to an armature 150 that partially resides within a coil 120. The coil 120 is in electrical contact with a wire 110 that is configured to supply a varying current, such as an alternating current, to coil 120 and through electromagnetic inductance the coil 120 vibrates the armature 150 and the armature 150 vibrates the diffuser 130 in a longitudinal direction to the center of the coil 120.

In some embodiments a current supplied to coil 120 may be a varying direct current, or any suitable current or voltage variations that actuate the armature 150 to vibrate. For example, the electrical variations through the coil 120 may provide varying movements of the armature that are not pure vibrations around an equilibrium point, or may be other than periodic, yet sufficiently move the diffuser 130 to reduce speckle in a generated image.

A force applied to the armature 150 is typically proportional to the change in inductance of the coil 120 with respect to the change in position of the armature 150, and the current flowing through the coil 120 as supplied by wire 110. In this manner, some embodiments having a diffuser 130 coupled with armature 150, wherein the armature 150 is actuated by electromagnetic properties of the coil 120, and the diffuser 130 may reduce or substantially eliminate the appearance of speckle in a generated image by vibrating within the optical path of a laser light beam.

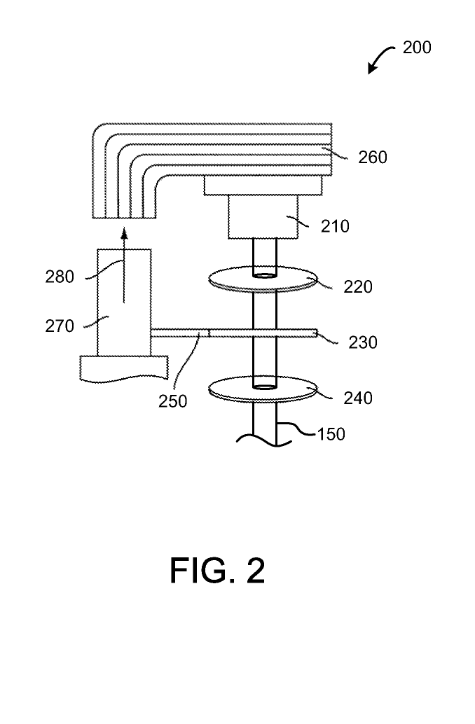

In another embodiment, an armature 150 may be coupled to a speaker driver directly to mechanically move a diffuser, or indirectly such as to create a plenum to provide pulsing air pressure variations as explained more fully below with reference to the embodiment illustrated in FIG. 2. In some embodiments, a diffuser 130 may be directly coupled with the speaker driver and be configured to move in relation to speaker driver movements, and therefore generate vibrations in the diffuser 130 that reduce the appearance of speckle in a generated image.

In some embodiments, the diffuser 130 may be coupled to structure in a display device that provides other functions, in this way a display device may enjoy the utility provided by a diffuser to reduce speckle while also not requiring a separate and dedicated motor to vibrate the diffuser 130. The absence of a separate and dedicated motor, and therefore the reuse of other functional structure in the display device, allows a less expensive, cooler operating, less power consuming and otherwise more efficient solution for reducing speckle in a projected image.

Embodiments may advantageously use different diffusers. For example, a ½ degree diffuser may be more appropriate for some applications by reducing speckle while not broadening an illumination beam beyond optics within a device and thus decreasing projected lumens. In another embodiment, a 2 degree diffuser may work well in devices with short illumination paths to an imaging device while providing adequate speckle reduction due to the 2 degree diffusion of the laser light. Further, optical diffusers use different methods to diffuse light. For example, optical diffusers may be ground glass diffusers, holographic diffusers, opal diffusers, grayed glass diffusers, etc. Different types of diffusers may then be tailored to geometries of a display device and certain frequencies of a laser light source to effectively reduce speckle in projected images.

FIG. 2 shows a schematic depiction of an embodiment 200 utilizing the vibration of an air jet 270 to vibrate a diffuser 230 according to the present disclosure. As shown, a projection system may include a laser 210 positioned to generate an illumination beam to then be passed through an imaging device (not shown) and allow the projection system to display an image, where light 150 is directed along a light path through a first set of optics 220, through the diffuser 230, and through a second set of optics 240 and then on to the imaging device. The laser 210 may further be operatively coupled to a heat sink 260 positioned near an air jet 270 or other cooling device. Some embodiments may couple the diffuser 230 to the housing of air jet 270 using a parasitic vibration arm 250.

In some embodiments, the parasitic vibration arm 250 may be moved by pressure variations around a plenum of the air jet, or be attached to some structure of the jet, so that the air pressure fluctuations caused by the air jet 270 operatively move the parasitic vibration arm 250 and therefore the diffuser 230. The vibrations in the diffuser 230 may therefore reduce the appearance of speckle in a generated image.

In some embodiments, a diffuser 130 may be configured to move in relation to pressure variations generated by the air jet 270 while not having a direct mechanical linkage to the air jet 270. In these embodiments it is advantageous to utilize pressure variations that do not interfere with the main pulse of air 280 generated by the jet which is intended to pass over the heat sink and in turn aid cooling of the laser 210.

In some embodiments, a conventional air jet 270 may vibrate near 100 HZ. This vibration is sufficient vibrate the diffuser 230 in a manner to reduce or substantially eliminate speckle in a projected image. Thus, the air jet 270 vibration may be channeled to the diffuser 230 though the arm 250. In such a manner, vibrations in the air near the air jet 270 may functionally replace a diffuser vibration motor.

Although described in regards to an air jet, it should be appreciated that other components may be used to produce the desired vibrations. For example, a projector may include a fan to cool the main projector enclosure. Vibrations from the fan, the motor to power the fan, or through the structure supporting the fan can be used to vibrate a diffuser or a parasitic vibration arm attached to the diffuser. Additionally, arms or extensions may be used to transfer vibrations from such components to the diffuser. It should be appreciated that in some embodiments, multiple arms, extensions or other suitable couplings may be provided to link the air jet with the diffuser.

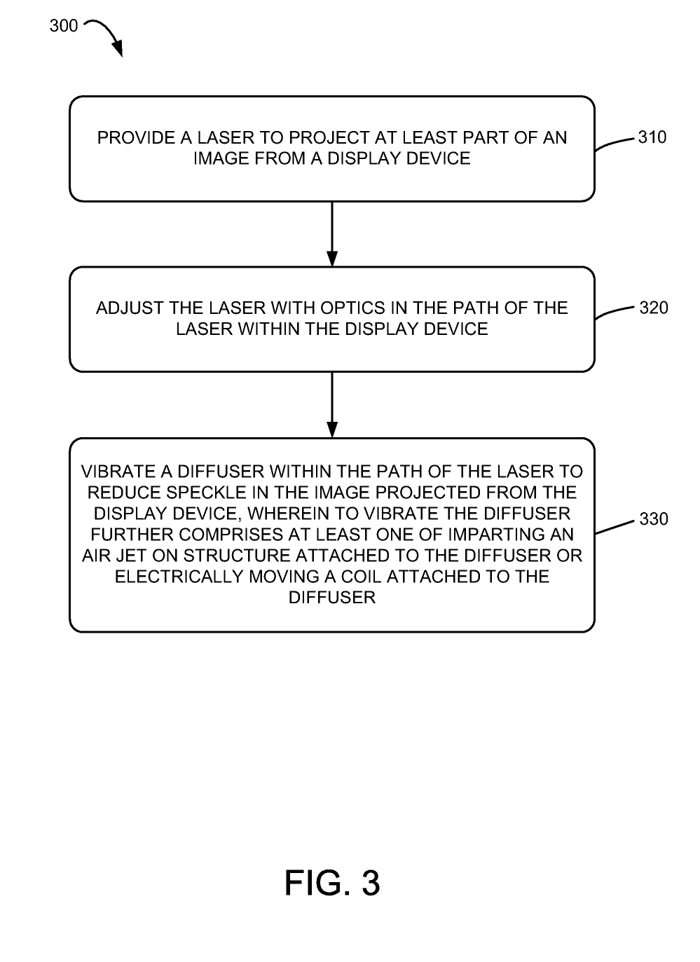

FIG. 3 is a flow diagram of a method 300 of vibrating a diffuser in a display device in order to reduce speckle in a projected image. In block 310, a laser is provided to project at least part of an image from a display device. Then, in block 320 the method uses optics within the path of the laser light to adjust the laser light within the display device. Method 300 then vibrates a diffuser within the path of the laser light to reduce speckle in the image projected from the display device, wherein the diffuser is vibrated with at least one of an air jet imparted on structure attached to the diffuser or by electrically moving a coil attached to the diffuser. Some embodiments may comprise methods that utilize other principles described within this disclosure, and their equivalents.

The use of components within the laser projection system to generate the vibrations for the diffuser may reduce cost for the system. Further, as space is at a premium in many small projection systems, elimination of an extra motor may enable reduced-sized projection device without loss of image quality.

The above-described arrangement of alternative systems for generating vibrations to a diffuser may help to overcome cost constraints and other various problems associated with the use of dedicated diffuser vibration motor as provided in known laser projection systems. This may help to make the laser systems more suitable for use in small-scale projection systems, including but not limited to pocket-sized systems.

While the disclosed arrangement of alternative sources for generating vibrations such as a speaker driver and the vibrations of the air jet are described in the figures and above, it should be appreciated that such components are provided as examples and other components may also be used to generate the desired vibrations for the diffuser or other similar component to reduce speckle in a projected image.

It is believed that the disclosure set forth above encompasses multiple distinct inventions with independent utility. While each of these inventions has been disclosed in its preferred form, the specific embodiments thereof as disclosed and illustrated herein are not to be considered in a limiting sense as numerous variations are possible. The subject matter of the inventions includes all novel and non-obvious combinations and subcombinations of the various elements, features, functions and/or properties disclosed herein.

Inventions embodied in various combinations and subcombinations of features, functions, elements, and/or properties may be claimed in a related application. Such claims, whether they are directed to a different invention or directed to the same invention, whether different, broader, narrower or equal in scope to any original claims, are also regarded as included within the subject matter of the inventions of the present disclosure.

What is claimed is:

1. An image display device, comprising:
a laser light source to provide a laser light to an imaging device, wherein the laser light is configured to project at least a portion of an image from the display device onto a surface;
optics in an optical path of the laser light, the optics to optically adjust the laser light;
a diffuser in the optical path of the laser light between the laser light source and the imaging device; and
a coil connected to the diffuser, wherein the diffuser is vibrated by a change in electrical current through the coil, and the diffuser is configured to diffuse the laser light and reduce speckle in the image.

2. The image display device of claim 1, wherein the coil is a speaker driver.

3. The image display device of claim 1, wherein the coil is within an optical pickup head.

4. The image display device of claim 1, wherein the coil is a portion of a fan assembly used to cool the image display device.

5. The image display device of claim 1, wherein the coil is used to vibrate the diffuser and power at least one other function for the display device.

6. The image display device of claim 1, wherein the diffuser is vibrated at a frequency of at least 60 Hertz.

7. An image display device, comprising:
a laser light source to provide a laser light to an imaging device, wherein the laser light is configured to project at least a portion of an image from the display device onto a surface;
optics in an optical path of the laser light, the optics to optically adjust the laser light;
a diffuser in the optical path of the laser light between the laser light source and the imaging device; and
a parasitic vibration arm connected to the diffuser, wherein the parasitic vibration arm is vibrated by an air jet, the diffuser is vibrated by the parasitic vibration arm, and the diffuser is configured to diffuse the laser light and reduce speckle in the image.

8. The image display device of claim 7, wherein the diffuser is vibrated at a frequency of at least 60 Hertz.

9. A method for reducing speckle in a laser display device, the method comprising:
providing a laser light to an imaging device to then project at least part of an image from a display device;
adjusting the laser light with optics in the path of the laser light within the display device;
vibrating a diffuser within the path of the laser between a laser light source and the imaging device light to reduce speckle in the image projected from the display device, wherein vibrating the diffuser further comprises electrically moving a coil attached to the diffuser.

10. The method of claim 9, further comprising vibrating the diffuser at a frequency of at least 60 Hertz.

11. The method of claim 9, wherein the coil is a speaker driver.

12. The method of claim 9, wherein the coil is within an optical pickup head.

13. The method of claim 9, wherein the coil is a portion of a fan assembly used to cool the image display device.

14. The method of claim 9, further comprising vibrating the diffuser with the coil, and using the coil to power at least one other function for the display device.

15. A method for reducing speckle in a laser display device, the method comprising:
providing a laser light to an imaging device to project at least part of an image from a display device;
adjusting the laser light with optics in the path of the laser light within the display device;
vibrating a diffuser within the path of the laser light between a laser light source and the imaging device to reduce speckle in the image projected from the display device, wherein vibrating the diffuser further comprises imparting an air jet on structure attached to the diffuser.

16. The method of claim 15, further comprising vibrating the diffuser at a frequency of at least 60 Hertz.
